(19) United States
(12) Patent Application Publication
(10) Pub. No.: US 2016/0021518 A1
(43) Pub. Date: Jan. 21, 2016

(54) SYSTEM AND METHOD FOR COMMUNICATING ANONYMOUSLY

(71) Applicant: Shadow SMS, LLC, Leawood, KS (US)

(72) Inventors: Aaron Martens, Cave Creek, AZ (US); Gautam Sharma, Hermosa beach, CA (US)

(73) Assignee: SHADOW SMS, LLC, Leawood, KS (US)

(21) Appl. No.: 14/610,334

(22) Filed: Jan. 30, 2015

Related U.S. Application Data
(60) Provisional application No. 62/025,024, filed on Jul. 16, 2014.

(51) Int. Cl. H04W 4/14; H04W 12/02

(52) U.S. Cl. CPC H04W 4/14; H04W 12/02; H04W 4/02

(57) ABSTRACT

Method and system is disclosed for communicating anonymously between devices. The method includes storing a finite plurality of alias addresses in a database, provisioning a first alias of the finite plurality of alias addresses for a recipient device having a first real address in response to a request from an originating device, transmitting the first alias to the originating device, receiving a message from the originating device addressed to the first alias, identifying a real address associated with the first alias within the database, associating a second alias of the finite plurality of alias addresses for an originating device having a second real address within the database, associating the received message from the originating device with the first real address and the second alias within the database, and transmitting the received message to the recipient device associated with the first real address, wherein the transmitting includes providing the second alias as an originating address.

### CROSS REFERENCE TO RELATED APPLICATIONS

This application claims the benefit of U.S. Provisional Application No. 62/025,024 filed on Jul. 16, 2014 which is hereby incorporated herein by reference.

### TECHNICAL FIELD

This disclosure relates generally to anonymous wireless communication and more specifically to systems and methods of anonymous communication between two mobile device users.

### BACKGROUND

The statements in this section merely provide background information related to the present disclosure and may not constitute prior art.

Short message service (SMS) based communication services enable sharing of text-only messages between mobile devices. A typical protocol for sending SMS messages limits text to 160 characters per message. Multimedia messaging service (MMS) based messaging services extend SMS capability by enabling inclusion of multimedia content, e.g., graphical images, in messages sent between mobile devices.

In the past, the SMS technology has not been very good at providing anonymity to users. There is little or no provision to protect the identity of a user using the default text-messaging application that is shipped or installed as default with the mobile phone handset. There is no seamless method of protecting a user's caller identification in SMS messages sent from the default SMS application. Hence there is a need for applications and processes that provide for anonymous messaging, e.g., the originating party knows the identity and contact information of the second party while the receiving party is not aware of the originating party's identity.

### SUMMARY

Method and system is disclosed for communicating anonymously between devices. The method includes storing a finite plurality of alias addresses in a database, provisioning a first alias of the finite plurality of alias addresses for a recipient device having a first real address in response to a request from an originating device, transmitting the first alias to the originating device, receiving a message from the originating device addressed to the first alias, identifying a real address associated with the first alias within the database, associating a second alias of the finite plurality of alias addresses for an originating device having a second real address within the database, associating the received message from the originating device with the first real address and the second alias within the database, and transmitting the received message to the recipient device associated with the first real address, wherein the transmitting includes providing the second alias as an originating address.

Certain embodiments of the invention include a feature of communicating anonymously using SMS-type messages and/or MMS-type messages.

Certain embodiments of the invention include a feature of supplying a predetermined ASCII character sequence before the first real address to execute the request for provisioning a recipient device.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 is a high-level overview schematic diagram illustrating an exemplary system for anonymous communication, in accordance with the present disclosure;

FIG. 2 shows an exemplary computing device, in accordance with the present disclosure; and

FIG. 3 illustrates an exemplary sequence diagram depicting an anonymous communication between a first user and a second user, whereby the first user is anonymous to the second user, in accordance with the present disclosure.

### DETAILED DESCRIPTION

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

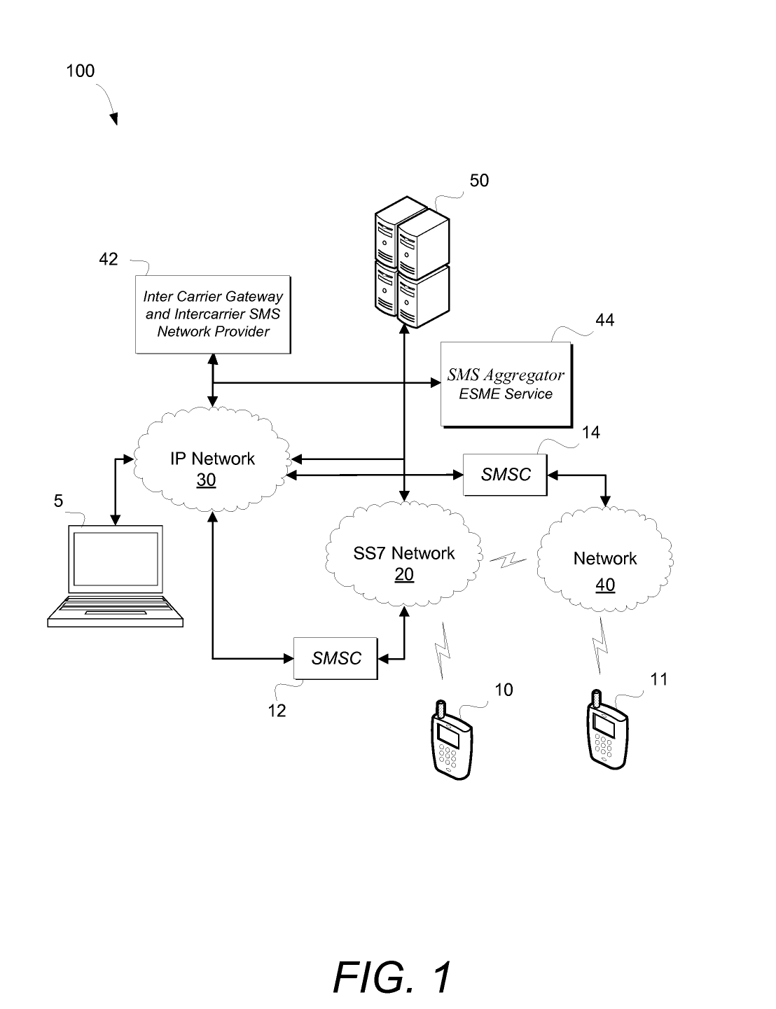

FIG. 1 includes various operationally and communicatively interconnected networks of various topologies, including a wireless SS7 network 20 in which various communications based upon a Mobile Application Part (MAP) based protocols, e.g., GSM MAP and IS41 MAP, for example, may be exchanged with various interconnected network elements to provide mobile telecommunications. An exemplary wireless network 20 is a signaling system 7 (SS7) network in which MAP short message service (SMS) and other MAP messages are exchanged, transferred, or otherwise processed or utilized. With respect to the present disclosure, the network 20 allows exchange of SMS messages to and from wireless mobile devices 10, wherein the various systems and methods of the invention are applicable to anonymize various communications between mobile devices 10 and 11 and/or computing devices 5.

In various embodiments, additional network elements may be included among or within the networks 20, 30, and 40 such as a short message service center (SMSC) 12, a single mobile switching center (MSC) and an associated home location register (HLR), although it will be appreciated that the system 100 may include any number of MSCs, HLRs, visitor location registers (VLR), as well as base station systems, base station controllers, etc., and other network elements (not shown) for implementing the teachings herein.

The network 20 may be communicatively connected with an Internet Protocol (IP) network 30 or other packet-based network for providing communications with one or more IP-based devices, such as a computing device 5, wherein the IP-based system 30 is communicatively connected to one or more network servers for coupling the packet-switched IP network 30 with the network 20. In various embodiments, the network servers are configured to provide inter carrier gateway routing and SMPP short messaging (SMS) services between IP-based devices computing devices 5 and the exemplary mobile device 10 and other devices associated with the network 20, e.g., the application server 50. In various embodiments, the SMPP SMS services can be resident on one network element or can be distributed across multiple network elements within the networks 20 and 30. In various embodiments, the one or more network servers 40 are communicatively connected to one or more SMS aggregation and ESME services 42.

In various embodiments, the network 40 may include any suitable series of points or nodes interconnected by communication paths. The network 40 may be interconnected with other networks and contain sub networks network such as, for example, a publicly accessible distributed network like the Internet. In one embodiment, the network 40 includes an IP-based network similar to network 30. Elements of the network 40 may provide inter carrier gateway routing and SMPP SMS services among IP-based devices such as the computing devices 5, the mobile device 10 and the mobile device 11. In various embodiments, the network 20 may be communicatively coupled to one or more additional networks 40 for message exchange between a mobile device 10 connected to the first network 20 and a mobile communications device 11 communicatively connected to the second network 40. The network 40 may be communicatively connected to a short message service center 14 to allow devices such as the mobile device 11 to send SMPP SMS messages via the IP network 30 or similar.

The IP network 30 may operate to transfer SMPP SMS messages from External Short Messaging Entity (ESME) sources such as the computing device 5 or other ESME communicatively connected with the IP network 30 to communications devices associated with the wireless network 20 via the SMSC 12, and also allows devices such as the mobile device 10 to send SMPP SMS messages to the ESME 5 via the SMSC 12 and the IP network 30. In this way, networks 20 and 30 can provide communicative connection of various communications devices and network elements for various communications and anonymous communications, as described herein below, including, e.g., inter carrier gateway routing to one or more foreign networks. In various embodiments, the IP network 30 may operate to transfer MMS messages from one or more mobile devices, e.g., devices 10 and 11, through the SMSC 12 and/or SMSC 14.

SMS and MMS messages may be directed through networks 20, 30, and/or 40 using real addresses associated with a particular device. In one embodiment the read address is a North American Numbering Plan Administration (NANPA) telephone number. NANPA telephone numbers may be ten-digit numbers consisting of a three-digit Numbering Plan Area (NPA) code (or area code), followed by a seven-digit number. In one embodiment, the real address is a Session Initiation Protocol (SIP) address. The SIP address may include a Uniform Resource Identifier. In one embodiment, the real address is a E.164-type address. In various embodiments, the real address may be formatted according to a particular network protocol utilized by connected and registered devices such as VoLTE, VoWifi, RCS, and WebRTC type messaging networks.

An application server 50 is preferably communicatively connected through the IP network 30 via various SMPP or web services based communications tools, e.g., API. The application server 50 can be any suitable combination of hardware, software, logic, etc., whether unitary or distributed, whereby the various anonymizing aspects of the disclosure can be easily scaled according to network traffic conditions on a dynamic basis. The application server 50 in the illustrated embodiment can be accessed for programming via a computing device 5 communicatively connected with the network 30 for adaptation, programming, updating, etc. by a user and/or a service provider for configuring one or more parameters associated with the anonymizing features described herein.

The application server 50 may be various embodiments of a computer including high-speed microcomputers, minicomputers, mainframes, and/or data storage devices. The application server 50 may be configured to execute database functions including storing and maintaining a database and processes requests from the mobile devices 10 and 11 and the computing device 5 to extract data from, or update, a database. The application server 50 may additionally provide processing functions for the mobile devices 10 and 11 and the computing device 5 as will become apparent to those skilled in the art upon a careful reading of the teachings herein.

In addition, the mobile device 10 may include one or more applications that the user may operate. Operation may include downloading, installing, turning on, unlocking, activating, or otherwise using the application. The application may comprise at least one of an algorithm, software, computer code, and/or the like, for example, mobile application software. In the alternative, the application may be a website accessible through the world wide web.

The computing device 5 and the application server 50 may be various embodiments of a computer including high-speed microcomputers, minicomputers, mainframes, and/or data storage devices without departing from the teachings herein.

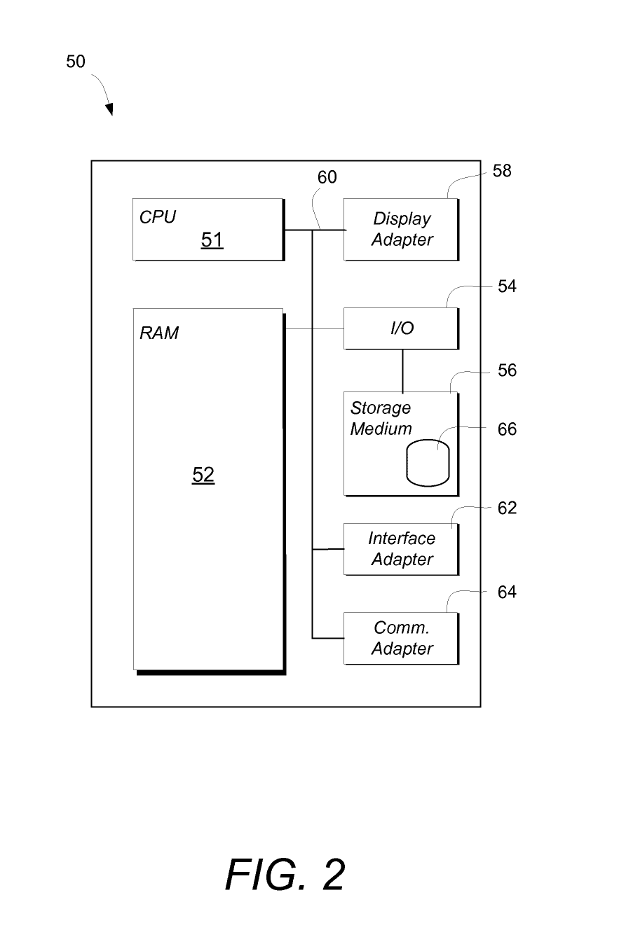

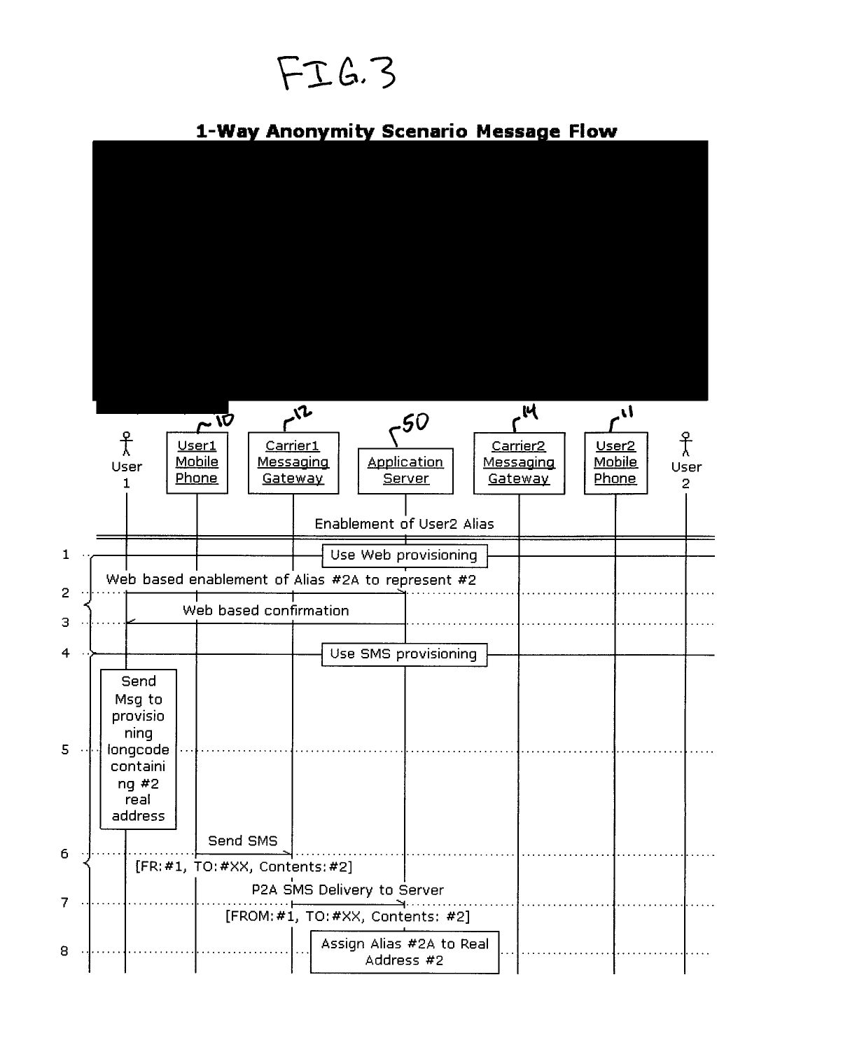

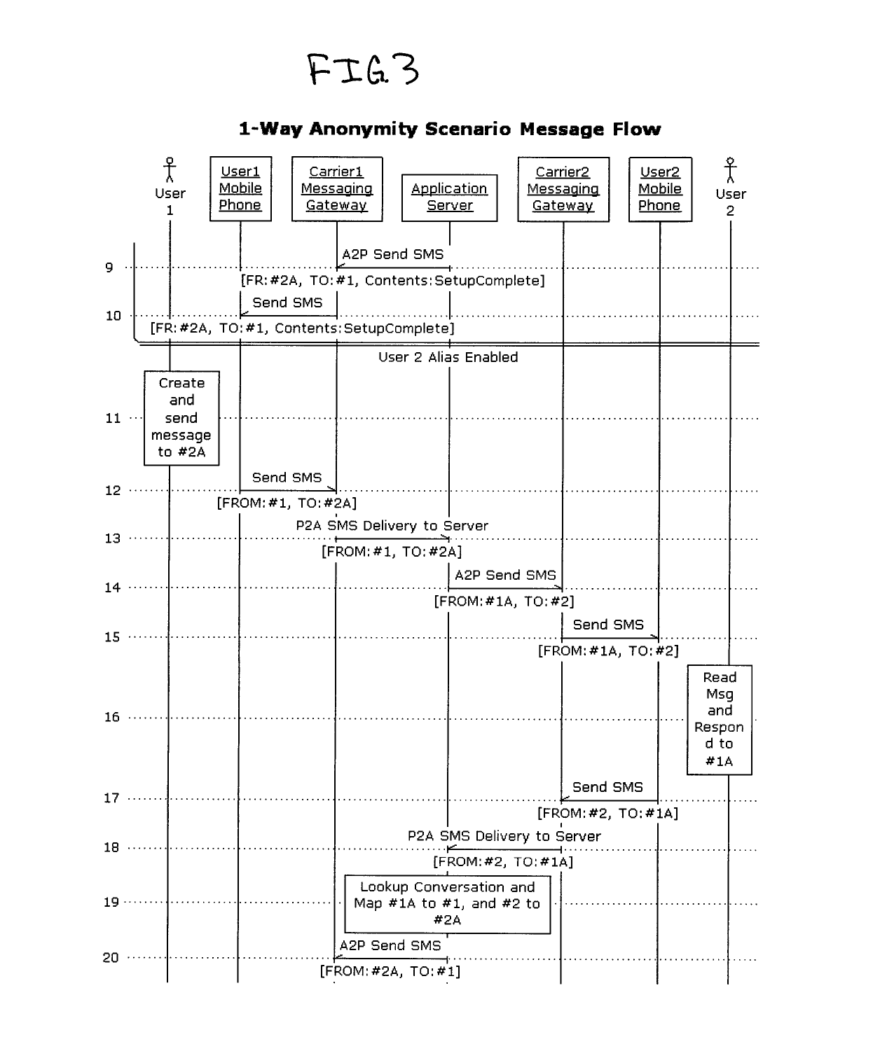

FIG. 2 shows the exemplary computing device and may be used in various embodiments of the application server 50. The computing device includes a central processing unit (CPU) 51, random access memory (RAM) 52, input/output circuitry 54 for connecting peripheral devices such as a storage medium 56 to a system bus 60, a display adapter 58 for connecting the system bus 60 to a display device, a user interface adapter 62 for connecting user input devices such as a keyboard, a mouse, and/or a microphone, to the system bus 60, and a communication adapter 64 for connecting the computing device to the network 20. In one embodiment, the communication adapter 64 is a wireless adapter configured for extraterrestrial communication such as in a communications satellite. The storage medium 56 is configured to store, access, and modify a database 66, and is preferably configured to store, access, and modify structured or unstructured databases for data including, for example, relational data, tabular data, audio/video data, and graphical data.

The central processing unit 51 is preferably one or more general-purpose microprocessor or central processing unit(s) and has a set of control algorithms, comprising resident program instructions and calibrations stored in the memory 52 and executed to provide the desired functions including parallel processing functions. As one skilled in the art will recognize, the central processing unit 51 may have any number of processing “cores” or electronic architecture configured to execute processes in parallel. In one embodiment, an application program interface (API) is preferably executed by the operating system for computer applications to make requests of the operating system or other computer applications. The description of the central processing unit 51 is meant to be illustrative, and not restrictive to the disclosure, and those skilled in the art will appreciate that the disclosure may also be implemented on platforms and operating systems other than those mentioned.

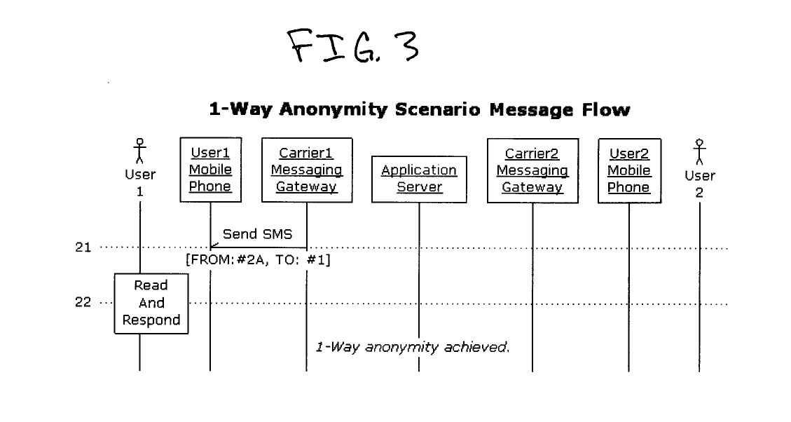

FIG. 3 illustrates an exemplary sequence diagram depicting an anonymous communication flow between a first user 1 and a second user 2, whereby the first user 1 is anonymous to the second user 2. In one exemplary communication operation, the user 1 may initiate a communication to a specified user 2. In various embodiments, user 1 may enable provisioning the alias for user 2 through a communication from the user's mobile device 10 sent to a carrier gateway center which may be the SMSC 12, and then on to the application server 50. Upon initiating the communication, a provisioning sequence is executed, generating an alias for user 1 to identify user 2, i.e., an alias associated with user 2. In one embodiment, the application server 50 may then send confirmation of a successful alias generation to the user 1. In various embodiments, the alias is a longcode.

In various embodiments, the application server 50 includes a finite number of longcodes for association with users, e.g., between 500 and 1,000 longcodes. The finite number of longcodes may be dynamic. For example, the finite number of longcodes may be exchanged, replaced, or modified at predetermined time periods, upon occurrence of predetermined events, and/or selectively based upon admin-user inputs. In one embodiment, alias longcodes may be associated with geographical regions. In this way, a user initiating the provisioning sequence may be assigned, or have assigned to a recipient, a longcode associated with a geographical location corresponding to the user. In various embodiments, an originating user provisions a guest recipient with an alias.

In one embodiment utilizing SMS provisioning, the user 1 initiates a message communication to user 2 by sending the message to a predefined provisioning longcode or provisioning address, wherein the message includes the real address of user 2, e.g., a phone number. The messaging address is from the user's mobile device 10 to the gateway center 12 and then to the application server 50.

In various embodiments, the user 1 may initiate the provisioning process by sending a message to a specially pre-assigned address or 10 digit longcode, in one embodiment, whereby the message includes a real address associated with user 2, e.g., user 2's phone number. In some embodiments, the pre-assigned address or longcode is a 10 digit phone number associated with the application server 50. In one embodiment, the user 1 may simply enable the provisioning and anonymous communication to the application server 50 by sending a predetermined ASCII character sequence, e.g., @@ followed by the intended recipient's real address. In this way, the request for anonymous communication is sent to the application server 50 automatically, without requiring explicit addressing by the user 1.

In one embodiment, the message may be sent along with an intended text block message, in the body of the message, with a specified delimiter (e.g., a space) between the user 2's real address and a beginning of the text block. In one embodiment, the user 1 may send the intended text block message after receiving confirmation of successful provisioning. SMS messages sent to a long code are forwarded to the server 50 switch by the sender's mobile service provider, e.g., network 20 operator, which then posts the message details to the messaging gateway, e.g., SMSC 12.

The application server 50 receives the originating message including the real address of user 2. The application server 50 parses the message of the real address associated with user 2 and generates an alias for association to the real address of user 2. The application server 50 may then send confirmation of successful alias generation to the user 1, e.g., “setup complete”, through the gateway center 12 and mobile device 10 in the form of a SMS communication. In one embodiment, the application server 50 sends a message to the user 1 in response to the successful alias generation so that the user 1 may simply respond to the message. In various mobile device embodiments, the receipt of a message initiates a conversation module. By sending a message to the user 1 in response to the successful alias generation, response to that message by user 1 are sent to user 2 anonymously without requiring additional input from user 1.

Subsequent to successful generation and setup of an alias for association to user 2, the user 1 may send an information message to user 2 by addressing to the generated alias associated with user 2, e.g., “2A.” The message is generated and sent via SMS on the mobile device 10 of user 1 to the gateway center 12 and then to the application server 50. The application server 50 receives the message from user 1 as a message addressed to the generated alias address 2A. In order to anonymize user 1 and the mobile device 10 of user 1, the application server 50 associates a generated alias for user 1, e.g., “1A”, before transmitting the message to user 2 and the mobile device 11 associated with user 2.

Upon or subsequent to generating the alias associated with user 1, e.g., “1A” or user 1's mobile device 10, the application server 50 looks up the corresponding address and sends out the message to user 2 by addressing the real address associated with the mobile device 11 associated with user 2, e.g., from 1A to user 2. The application server 50 may transmit the message to the real address of user 2 by sending out through any number of network components including the gateway center 12 or gateway center 14 associated with a network 40 that corresponds to the mobile device 11. The gateway center 14 may then receive and transmit the message to the mobile device 11. User 2 and the mobile device 11 receive the message, seemingly from address 1A and not a real address associated with user 1 and mobile device 10. In this way, user 1 and mobile device 10 is anonymous from user 2 and mobile device 11.

In order to respond to the message, user 2 and mobile device 11 simply send out the responding message addressed to “1A.” The responding message is transmitted through network elements that may include gateway center 14 to the application server 50. The application server 50 looks up a user and/or mobile device associated with address 1A. Upon successful identification, the application server 50 forwards the responding message to user 1 and mobile device 10 which may be received and forwarded by any number of network elements including gateway center 12.

In some embodiments, a user may initiate anonymous messaging through a software or web-based interface. The server 50 obtains registration information from a user 3, for example, which includes a name associated with user 3 and mobile telephone number, through a client side user interface. User 3 is assigned a long code, e.g., longcode3, which is stored in conjunction with user 3's registration information.

The SMS message, e.g., message3, is directed to a user, e.g., user 4, is sent from user 3 using the software interface. The interface accepts the user 3's mobile phone number, the recipient's i.e., user 4, mobile phone number, a body of message, and a ‘send’ request from user 3. Upon receiving input from user 3, message3 details are posted to the software messaging gateway, triggering the server 50. Once the server 50 receives a trigger, it parses the received message, extracting phone numbers and identifying address associated with either user 3 or user 4. The server 50 then determines if user 3 has been assigned a long code and retrieves that long code, e.g., longcode3. Once longcode3 is determined to be the long code assigned to user 3, the server 50 dispatches message3 to user 4 using longcode3 as the sender address. Longcode3 acts as user 3's alias to send message3 to user 4.

In other embodiments, users may send encrypted anonymous SMS messages. To send an encrypted message, the sender may use a long code reserved just for anonymous encrypted messages. In this scenario, once sent, the message body is encrypted using an encryption algorithm. Instead of sending the actual message, a link to the encrypted message stored in memory is sent to the recipient. To open the message, the recipient must use a key or phrase pre-determined by sender and receiver and encryption mechanism.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A method of communicating anonymously, the method comprising:
storing a finite plurality of alias addresses in a database;
in response to a request from an originating device, provisioning a first alias of the finite plurality of alias addresses for a recipient device having a first real address, wherein the request is executed by supplying a predetermined ASCII character sequence before the first real address;
transmitting the first alias to the originating device;
receiving a message from the originating device addressed to the first alias;
identifying a real address associated with the first alias within the database;
associating a second alias of the finite plurality of alias addresses for an originating device having a second real address within the database;
associating the received message from the originating device with the first real address and the second alias within the database; and
transmitting the received message to the recipient device associated with the first real address, wherein the transmitting includes providing the second alias as an originating address.

2. The method of claim 1, further comprising:
receiving a response message from the recipient, addressed to the second alias;
identifying the second real address as associated with the second alias;
associating the response message from the recipient device with the second alias and the second real address; and
transmitting the response message to the originating device associated with the second real address, wherein the transmitting includes the second alias.

3. The method of claim 2, wherein the message from the originating device is a short message service message; and
wherein the response message from the recipient device is a short message service message.

4. The method of claim 2, wherein the transmitting the received message to the recipient device associated with the first real address is executed without transmitting the first real address.

5. The method of claim 2, wherein the transmitting the received message to the recipient device associated with the first real address is executed as originating from the second alias.

6. The method of claim 2, wherein the first and second real addresses are phone numbers.

7. The method of claim 2, wherein the first and second aliases are longcodes.

8. The method of claim 1, wherein at least one of the finite plurality of alias addresses are associated with a geographical region.

9. The method of claim 1, further comprising:
dynamically modifying the finite plurality of alias addresses.

10. A system comprising: at least one processing unit; a memory, operatively connected to the at least one processing unit and storing instructions that, when executed by the at least one processing unit, cause the at least one processing unit to perform a method, the method comprising:
storing a finite plurality of alias addresses in a database;
in response to a request from an originating device, provisioning a first alias of the finite plurality of alias addresses for a recipient device having a first real address, wherein the request is executed by supplying a predetermined ASCII character sequence before the first real address;
transmitting the first alias to the originating device;
receiving a message from the originating device addressed to the first alias;
identifying a real address associated with the first alias within the database;
associating a second alias of the finite plurality of alias addresses for an originating device having a second real address within the database;
associating the received message from the originating device with the first real address and the second alias within the database; and
transmitting the received message to the recipient device associated with the first real address, wherein the transmitting includes providing the second alias as an originating address.

11. The system of claim 10, wherein the method further comprises:
receiving a response message from the recipient device addressed to the second alias;
identifying the second real address within the database by the second real address's association with the second alias;
associating the response message from the recipient device with the first alias within the database; and
transmitting the response message to the originating device associated with the second real address, wherein the transmitting includes the first alias.

12. The system of claim 11, wherein the message from the originating device is a short message service message; and
wherein the response message from the recipient device is a short message service message.

13. The system of claim 11, wherein the transmitting the received message to the recipient device associated with the first real address is executed without transmitting the second real address.

14. The system of claim 11, wherein the transmitting the received message to the recipient device associated with the first real address is executed as originating from the second alias.

15. The system of claim 11, wherein the first and second real addresses are phone numbers.

16. The system of claim 11, wherein the first and second aliases are longcodes.

17. The system of claim 11, wherein at least one of the finite plurality of alias addresses are associated with a geographical region.

18. A non-transitory computer-readable storage medium comprising computer-executable instructions for performing a method comprising:
storing a finite plurality of alias addresses in a database;
in response to a request from an originating device, provisioning a first alias of the finite plurality of alias addresses for a recipient device having a first real address, wherein the request is executed by supplying a predetermined ASCII character sequence before the first real address;
transmitting the first alias to the originating device;
receiving a message and an encryption request from the originating device addressed to the first alias;
encrypting the message;
identifying a real address associated with the first alias within the database;
associating a second alias of the finite plurality of alias addresses for an originating device having a second real address within the database;
associating the received message from the originating device with the first real address and the second alias within the database; and
transmitting instructions for obtaining the received message to the recipient device associated with the first real address, wherein the transmitting includes providing the second alias as an originating address; and
transmitting the message to the recipient upon receipt of a correct predefined key.

19. The method of claim 18, further comprising:
receiving a response message from the recipient, addressed to the second alias;
identifying the second real address as associated with the second alias;
associating the response message from the recipient device with the second alias and the second real address; and
transmitting the response message to the originating device associated with the second real address, wherein the transmitting includes the second alias.

20. The system of claim 19, wherein the transmitting the received message to the recipient device associated with the first real address is executed without transmitting the second real address.
